(19) United States
(12) Patent Application Publication
(10) Pub. No.: US 2011/0162021 A1
(43) Pub. Date: Jun. 30, 2011

(54) INTERNET PROTOCOL TV(IPTV) RECEIVER AND A METHOD FOR RECEIVING APPLICATION INFORMATION IN AN IPTV RECEIVER

(76) Inventor: Joon Hui Lee, Yongin-si Gyeonggi-do (KR)

(21) Appl. No.: 13/000,886

(22) PCT Filed: Jun. 26, 2009
(86) PCT No.: PCT/KR2009/003483

§ 371 Date: Dec. 22, 2010

Related U.S. Application Data
(60) Provisional application No. 61/076,135, filed on Jun. 26, 2008.
(60) Provisional application No. 61/076,145, filed on Jun. 27, 2008.

(51) Int. Cl. H04N 7/173

(52) U.S. Cl. 725/93

(57) ABSTRACT

An Internet Protocol TV (IPTV) receiver and a method for receiving application information in an IPTV receiver are provided. An IPTV receiver includes a network interface configured to receive an Internet Protocol (IP) packet delivering a content access descriptor including application information about an application related to a Content On Demand (COD) content, and a controller configured to receive a request for the COD content, request the content access descriptor and control to receive the application based on the application information.

### TECHNICAL FIELD

The present invention relates to an Internet Protocol TV (IPTV) receiver and a method for receiving application information in an IPTV receiver, and more particularly, to an IPTV receiver and a method for receiving application information in a IPTV receiver, which have interactivity with a service provider.

### BACKGROUND ART

Generally, in a related art broadcast receiver, a content produced by a broadcasting station is transmitted via an electric wave carrier medium such as terrestrial, cable, satellite broadcasting and the like. A user then views the content received via a receiver capable of receiving the corresponding carrier medium.

As the digital broadcasting technology has been developed and commercialized from the conventional analog broadcasting, various kinds of content services such as real-time broadcasts, CoD (contents on demand), games, news and the like can be provided to users via internet network connected to homes as well as the conventional medium such as terrestrial, wireline cable and the like.

As an example for providing a content service using the internet network, there is IPTV (internet protocol TV). In the IPTV technology, various information services, moving picture contents, broadcasts and the like are transmitted via the internet network to be provided to a user's receiver. The internet network can be implemented on various kinds of networks including an optical cable network, a coaxial cable network, FTTH (fiber to the home), a phone network, a wireless network and the like based on IP (internet protocol).

In case of a service using the above-mentioned internet network, unlike the general terrestrial broadcast, interactivity can be added. Therefore, a user is facilitated to view a specific content service in a convenient time.

### DISCLOSURE OF INVENTION

### Technical Problem

An object of the present invention is to provide an Internet Protocol TV (IPTV) receiver and a method for receiving application information in an IPTV receiver, which are capable of, at the IPTV receiver, receiving an application related to a Content On Demand (COD) content.

Another object of the present invention is to provide an Internet Protocol TV (IPTV) receiver and a method for receiving application information in an IPTV receiver, which are capable of, at the IPTV receiver, identifying whether or not an application related to a COD content is downloaded.

### Technical Solution

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an Internet Protocol TV (IPTV) receiver, the IPTV receiver includes a network interface configured to receive an Internet Protocol (IP) packet delivering a content access descriptor including application information about an application related to a Content On Demand (COD) content, and a controller configured to receive a request for the COD content, request the content access descriptor and control to receive the application based on the application information. Herein, the application information includes at least one of application name information, application identification information, an application descriptor, an application specific descriptor and a provider descriptor.

In addition, the content access descriptor further includes relevant information related to fetch the COD content. The relevant information includes at least one of a content identifier, name information, description information, content type information, content size information and a content Uniform Resource Locator (URL). Herein, the controller controls to receive the COD content based on the relevant information.

In addition, the controller identifies whether the application is provided based on the application information.

In another aspect of the present invention, there is provided an IPTV receiver, the IPTV receiver including a network interface configured to receive an Internet Protocol (IP) packet delivering instance description metadata including application information about an application related to a Content On Demand (COD) content, and a controller configured to receive a request of the COD content, get instance metadata ID of a program location corresponding to the COD content, retrieve instance description metadata having the instance metadata ID and control to receive the application based on the application information included in the retrieved instance description metadata. Herein, the application information includes at least one of application name information, application identification information, an application descriptor, an application specific descriptor and a provider descriptor. Also, the instance description metadata includes a program location element, the program location element including at least one of a program element including a reference to a Content Reference Identifier (CRID), program Uniform Resource Locator (URL) element including a URL for specifying a program location, instance metadata ID element including the instance metadata ID and instance description element including descriptive information and the application information.

In addition, the controller identifies whether the application is provided based on the application information.

In another aspect of the present invention, there is provided a method for receiving application information in an Internet Protocol TV (IPTV) receiver, the method including receiving a request for a Content On Demand (COD) content and requesting a content access descriptor including application information about an application related to the requested Content On Demand (COD) content, and receiving an Internet Protocol (IP) packet delivering the content access descriptor and receiving the application based on the application information. Herein, the application information includes at least one of application name information, application identification information, an application descriptor, an application specific descriptor and a provider descriptor.

In addition, the method further includes identifying whether the application is provided based on the application information.

In addition, the content access descriptor further includes relevant information related to fetch the COD content. Herein, the relevant information includes at least one of a content identifier, name information, description information, content type information, content size information and a content Uniform Resource Locator (URL). Also, the receiving the application further includes receiving the COD content based on the relevant information.

In another aspect of the present invention, there is provided a method for receiving application information in an Internet Protocol TV (IPTV) receiver, the method including receiving a request of a Content On Demand (COD) content and getting instance metadata ID of a program location corresponding to the COD content, retrieving instance description metadata having the instance metadata ID, the instance description metadata including application information about an application related to a COD content, and receiving the application based on the application information included in the retrieved instance description metadata. Herein, the application information includes at least one of application name information, application identification information, an application descriptor, an application specific descriptor and a provider descriptor.

In addition, the method includes identifying whether the application is provided based on the application information.

In addition, the instance description metadata includes a program location element, the program location element including at least one of a program element including a reference to a Content Reference Identifier (CRID), program Uniform Resource Locator (URL) element including a URL for specifying a program location, instance metadata ID element including the instance metadata ID and instance description element including descriptive information and the application information.

It is to be understood that both the foregoing general description and the following detailed description of the present invention are exemplary and explanatory and are intended to provide further explanation of the invention as claimed.

### Advantageous Effects

In an Internet Protocol TV (IPTV) receiver and a method for receiving application information in an IPTV receiver according to the present invention, since the IPTV receiver receives a content access descriptor including application information about an application related to a COD content, it is possible for a service provider to announce application list related to a COD content and to signal information about each application. Also, it is possible for an IPTV receiver to consume a COD content with the application and provide an opportunity to select an execution of the application to the user.

Also, in an Internet Protocol TV (IPTV) receiver and a method for receiving application information in an IPTV receiver according to the present invention, since the IPTV receiver receives instance description metadata including application information about an application related to a COD content, it is possible for a service provider to announce application list related to a COD content and to signal information about each application. Also, it is possible for an IPTV receiver to consume a COD content with the application and provide an opportunity to select an execution of the application to the user.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of an IPTV system according to one preferred embodiment of the present invention,

FIG. 2A and FIG. 2B are schematic diagrams of multicast and unicast schemes, respectively,

FIG. 3 is a flowchart of a service discovery process,

FIG. 4 is a view showing an XML schema of an exemplary embodiment of a content access descriptor type,

FIG. 5 is a view showing an XML schema of an exemplary embodiment of an application list type,

FIG. 6 is a view showing an XML schema of an exemplary embodiment of an application type,

FIG. 7 is a view showing an XML schema of an exemplary embodiment of an application identifier type,

FIG. 8 is a view showing an XML schema of an exemplary embodiment of an application descriptor type,

FIG. 9 is a view showing an XML schema of an exemplary embodiment of a visibility descriptor type,

FIG. 10 is a view showing an XML schema of an exemplary embodiment of an icon descriptor type,

FIG. 11 is a view showing an XML schema of an exemplary embodiment of an aspect ratio type,

FIG. 12 is a view showing an XML schema of an exemplary embodiment of a mhp version type,

FIG. 13 is a view showing an XML schema of an exemplary embodiment of an application type,

FIG. 14 is a view showing an XML schema of an exemplary embodiment of an application control code type,

FIG. 15 is a view showing an XML schema of an exemplary embodiment of an application specific descriptor type.

FIG. 16 is a view showing an XML schema of an exemplary embodiment of a provider descriptor type,

FIG. 17 is a view showing an XML schema of an exemplary embodiment of a provider export descriptor type,

FIG. 18 is a view showing an XML schema of an exemplary embodiment of a provider usage descriptor type,

FIG. 19 is a block diagram of an IPTV receiver according to one preferred embodiment of the present invention,

FIG. 20 is a flowchart of a method for receiving application in an IPTV receiver to one preferred embodiment of the present invention,

FIG. 21 is a view showing an XML schema of an exemplary embodiment of a program location type,

FIG. 22 is a view showing an XML schema of an exemplary embodiment of an instance description type,

FIG. 23 is a block diagram of an IPTV receiver according to another preferred embodiment of the present invention, and

FIG. 24 is a flowchart of a method for receiving application in an IPTV receiver to one preferred embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

Moreover, terminologies used currently and widely are selected as terminologies used in this disclosure of the present invention. In some cases, terminologies arbitrarily selected by the applicant are used for the description of the present invention. For this, the accurate or correct meanings are specified in detailed description of the corresponding part. Therefore, it is understood that the arbitrarily selected terminology is not only simply construed as the name of the terminology used in this disclosure but also construed as the meaning of the corresponding terminology.

In the following description, operations of an Internet Protocol TV (IPTV) receiver and a method for receiving application information in an IPTV receiver according to the present invention are explained in detail with reference to the accompanying drawings.

First of all, IPTV system, which is an example for a system capable of providing various contents using internet network, can mainly include a server, a network and a receiver (client).

The server of the IPTV system can include servers responsible for various functions, such as a service discovery & selection server, a streaming server, a content guide information server, a client information server, a pay information server and the like.

Among the above servers, the streaming server transmits the stored moving picture data encoded by Moving Picture Experts Group 2 (MPEG2), MPEG4 and the like to a user via network. For a protocol for the transmission, Real-Time Transport Protocol (RTP), RTP Control Protocol (RTCP) or the like is available.

In case of using Real-Time Streaming Protocol (RTSP), moving picture stream playback can be controlled to some extent through a function called a trick play such as pause, replay, stop and the like. The above protocols are just exemplary and other real-time transport protocols are available according to implementations.

The content guide information server is the server that provides information on various contents. In this case, content guide information is the information corresponding to Electronic Program Guide (EPG) information or Broadband Content Guide (BCG) and includes various kinds of information. The content guide information server stores content guide information data and provides the stored data to a receiver.

The service discovery & selection server provides a receiver with connection information on servers providing various content services such as broadcast, COD (contents on demand), game and the like, playback information and the like.

The network system includes an internet based network and gateways. The internet based network can use one of various IP based networks including an optical cable network, a coaxial cable network, Fiber To The Home (FTTH), a phone network, a wireless network and the like. The gateways can perform multicast group management using such a protocol as Internet Group Management Protocol (IGMP), Quality Of Service (QoS) management and the like as well as general data forwarding.

The IPTV receiver means the receiver capable of receiving data transported via internet network and then providing the received data to a user. The receiver includes one of IPTV settop, homenet gateway, IPTV embedded TV and the like.

Also, the IPTV receiver includes an Open IPTV Terminal Function (OITF). The OITF is a device having the functionality within the Consumer Network or a Mobile Terminal that is responsible for terminating the media and control for an IPTV Service. And the IPTV receiver includes a thin client controlling an IPTV service based on the browser interaction model and a thick client controlling an IPTV service based on the Service Discovery & Selection mechanism. The thick client receives metadata from a server and processes the metadata to control the IPTV service, but the thin client accesses a web page generated from the metadata by the server through a web browser and displays the web page.

In case of hybrid type IPTV system, various contents of internet can be provided as well as various conventional broadcast contents. In particular, various broadcast contents including terrestrial broadcast, cable broadcast, satellite broadcast, personal broadcast and the like, various internet picture contents, data contents except pictures and the like can be provided to a user. And, these contents can be provided by real time or by on-demand according to a request.

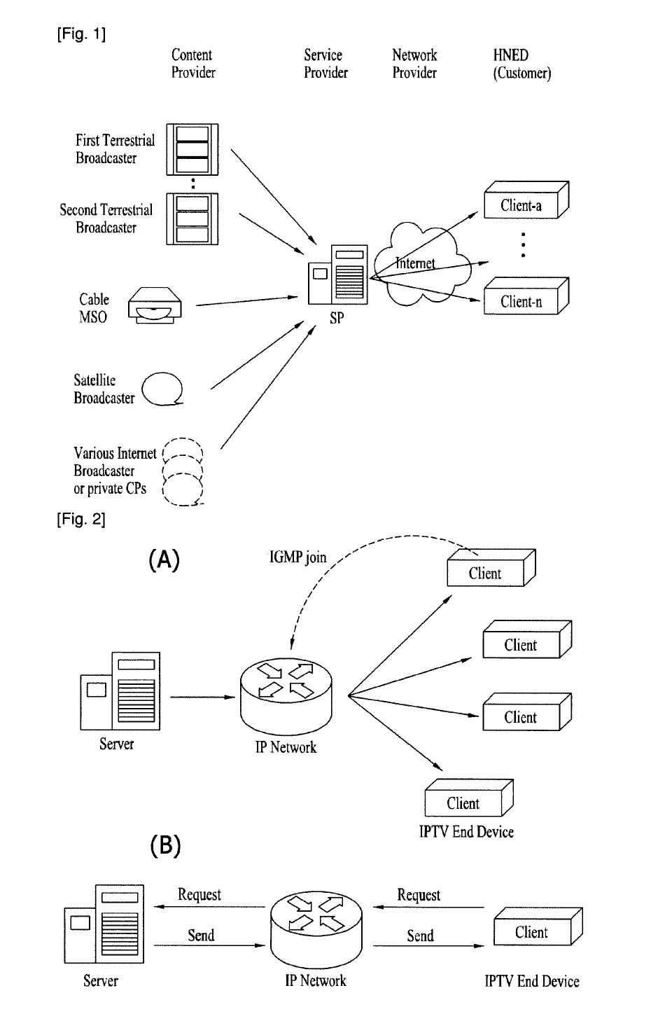

FIG. 1 is a diagram of an IPTV system according to one preferred embodiment of the present invention.

Referring to FIG. 1, in aspect of providing a content service, the IPTV system can include a content provider (CP), a service provider (SP), a network provider (NP) and a customer.

The content provider produces various contents to provide. As mentioned in the foregoing description of FIG. 1, the content provider can include one of a terrestrial broadcaster, a cable broadcast service operator (cable system operator (SO) or multiple system operator (MSO)), a satellite broadcaster, an internet broadcaster and the like.

The service provider renders contents provided by the content provider into a service package and then provides the service package. For instance, the service provider shown in FIG. 1 packetizes a first terrestrial broadcast, a second terrestrial broadcast, a cable MSO, a satellite broadcast, various internet broadcasts and the like and then provides the packetized broadcasts to a user.

The service provider provides a user with a service using a unicast or multicast scheme. FIG. 2A and FIG. 2B are schematic diagrams for a multicast scheme and a unicast scheme, respectively. In the unicast scheme, data is transported between a single transmitter and a single receiver by 1:1. For instance, in case of the unicast scheme, if a receiver makes a request for data to a server, the server transmits the data to the receiver in response to the request. In the multicast system, data is transmitted to a plurality of receivers of a specific group. For instance, a server is able to transmit data to a plurality of pre-registered receivers at a time. For the multicast registration, Internet Group Management Protocol (IGMP) is available.

Te network provider provides a network to provide the service to a Customer. The Customer can receive the service by establishing a home network (Home Network End User: HNED) as well.

For a means for protecting a content transported in the IPTV system, conditional access, content protection and the like are available. For example, CableCard, Down-loadable Conditional Access System (DCAS) or the like is available for the conditional access or content protection.

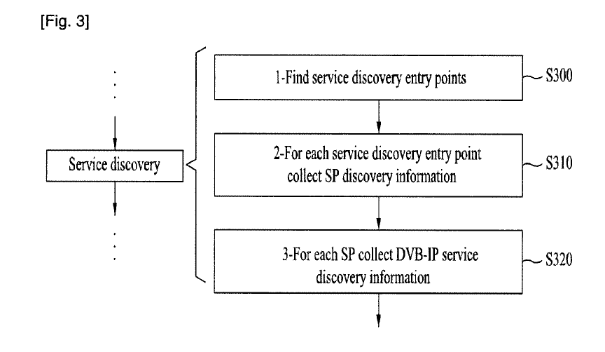

FIG. 3 is a flowchart of a service discovery process.

Referring to FIG. 3, in order for the IPTV receiver to provide a content to a user, the receiver discover a server storing a user-specific content therein and then accesses the discovered server. To discover the content server, the receiver is able to access an entry point of an IPTV portal (or a system operator (SO)) provided by a network provider [S300]. In this case, the entry point means a sort of an access location.

A user inputs an IP address/port or DNS (domain name system) URL (uniform resource locator) for the entry point of the IPTV portal or selects to input a pre-registered address or the like. Alternatively, the receiver is able to automatically access a pre-selected access or the like.

The entry point of the IPTV portal provides the receiver with a service provider discovery record containing information on each service provider [S310]. In the case, the service provider discovery record contains various kinds of information on a service provider. For instance, the various kinds of information contain service provider identification information, connection information and the like.

The receiver accesses a server of the service provider that provides a user-specific service using the information of the received service provider discovery record. And, the service provider provides the receiver with a service discovery record containing information on a content [S320]. In this case, the service discovery record contains various kinds of information on a content service. In this case, the service discovery record contains an access address of a service server storing the content and the like for example.

The receiver stores the received service discovery record. The receiver accesses the service server of the content provider providing the user-specific content using the information of the service discovery record and then receives a stream from the service server. In case of attempting to view a content provided on a different channel (or, a content provided by a different service server), the receiver accesses the service server of the corresponding content provider again using the information of the stored service discovery record.

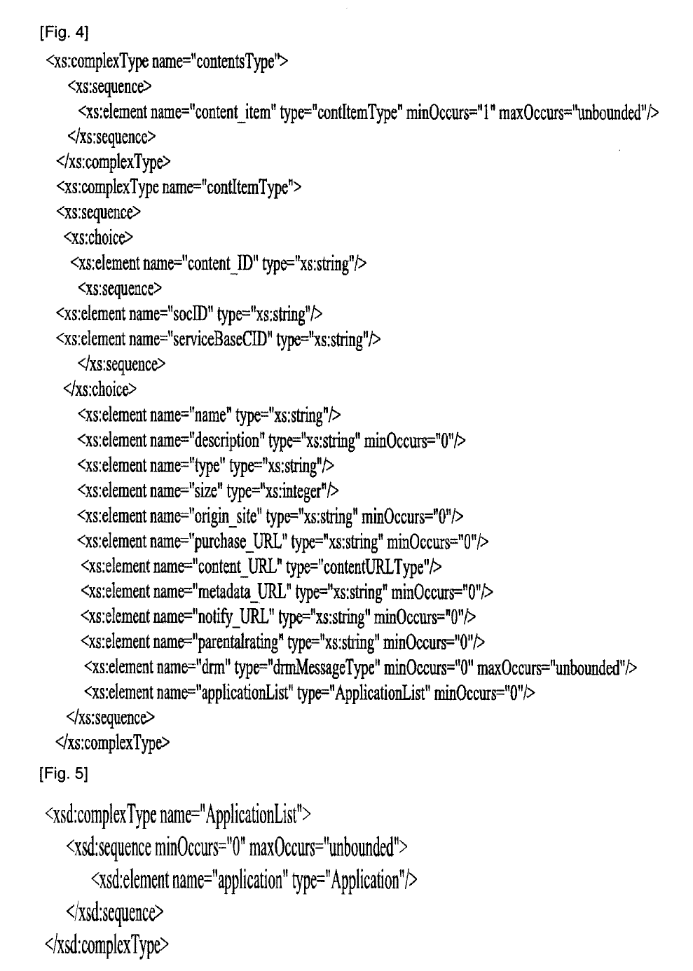

FIG. 4 is a view showing an XML schema of an exemplary embodiment of a content access descriptor type.

Referring to FIG. 4, a content access descriptor includes application information about an application related to a COD content and relevant information related to fetch the COD content. And the content access descriptor may be defined by the content access descriptor type. The content access descriptor type includes contents element being a container for one or more content_item elements as child element. the content_item elements may include the application information and the relevant information.

The relevant information includes at least one of a content identifier, name information, description information, content type information, content size information and a content Uniform Resource Locator (URL). Also, the relevant information may include one or more of a content_ID, a socID and a servicesBaseCID.

The content_ID indicates a unique (Marlin) content identifier for a content-item, if the content item is not scheduled content. If the content item denotes scheduled content, the socID and the serviceBaseCID are used, together with a pID extracted from the MPEG2_TS.

The socID is used in conjunction with the serviceBaseCID for creating a unique contentID for a pID extracted from the MPEG2_TS, if the content item denotes scheduled content.

The serviceBaseCID is used in conjunction with the socCID for creating a unique contentID for a pID extracted from the MPEG2_TS, if the content item denotes scheduled content.

The name information indicates a user interpretable name that serves as a basis/suggestion for the actual filename used for storing the downloaded content item. It is recommended for a remote UI client to not require the user to enter a filename and select the storage device for storing a downloaded content item.

The description information indicates a user interpretable description of the content item.

The content type information indicates the MIME-type of the content item. It is recommended for a remote UI client to inform the user if the content-type of a content item being downloaded cannot be interpreted by the client device.

The size information indicates the size of the content item in bytes. If the size is unknown (e.g. in case of streaming), the value of this element is −1. If the value is greater or equal to 0, the value given here SHALL correspond to the value given to the Content-Size HTTP header if the content is fetched through the content-URL. If after a download the size of the downloaded content item does not match the indicated size parameter, it is recommended for the remote UI client to remove the downloaded content item.

The content URL indicates the URL from which the content can be fetched. The element has a drmtype attribute, a download attribute and immediateplay attribute.

The drmtype attribute indicates the drm system for which this URL applies. The default value of the “type” attribute is an empty string, which indicates that the content is not DRM protected. Other valid values include “marlin”.

The download attribute, with boolean value (true|false), indicates if the content-item SHALL be downloaded and stored if it has value “true”. In case download is false, the content-item is meant for immediate playback. See bullet 2 of Section 4.3 for more details.

The immediateplay attribute, with boolean value (true|false), whereby a value true indicates if that the content-item is either streamed or supports being progressively downloaded, whereby the content is available for immediate playback whilst it is being fetched. The default value of the “immediateplay” attribute is “true”.

One or more of elements including the content URL may be included in the content item_element, if they have a different value for the “type” attribute.

The relevant information optionally includes origin site information, a purchase URL, a metadata URL, a notify URL, parental_rating information and drm information. the origin site information indicates the URL of the site from which this content access description document can be downloaded. Typically this is the site from which the content is/can be purchased (in that case the origin site information and the purchase URL information have the same value)

The purchase URL indicates the URL of the site where the license for the content can be purchased.

The metadata_URL indicates the URL from which additional metadata can be fetched for the content item, such as artwork, subtitle files.

The notify_URL indicates the URL to which an HTTP GET request shall be made when the content-item has been successfully fetched.

The parental_rating information indicates the parental rating for this content item.

The drm information allows the inclusion of an opaque block of data (e.g. a set of Marlin action tokens, or a license_URL) that shall be passed to the DRM agent. Has an msgTtype attribute, the drm information indicates the type of message (e.g. application/vnd.marlin.drm.actiontoken+xml). A single content_item element may have multiple elements including the drm information as child elements.

FIG. 5 is a view showing an XML schema of an exemplary embodiment of an application list type.

Referring to FIG. 5, the application information includes at least one of application name information, application identification information, an application descriptor, an application specific descriptor and a provider descriptor.

And the application information may be included in a applicationList element. The applicationList element is a child element of the content_item element and may be defined by the application list type. The application list type includes one or more application element as a child element.

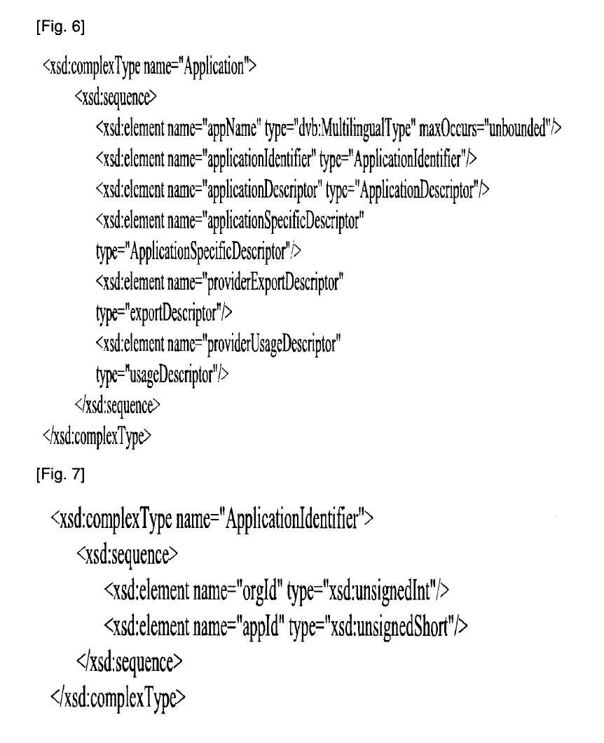

FIG. 6 is a view showing an XML schema of an exemplary embodiment of an application type.

Referring to FIG. 6, the application element may be defined by the application type. The application type includes appName element, applicationIdentifier element, applicationDescriptor element, applicationSpecificDescriptor element, providerExportDescriptor element and providerUsageDescriptor element.

The appName element includes the application name information. Herein, an application name can be multilingual.

FIG. 7 is a view showing an XML schema of an exemplary embodiment of an application identifier type.

Referring to FIG. 7, The applicationIdentifier element includes the application identification information including an organization identifier and an application identifier. The organization identifier is a globally unique value identifying the organization that is responsible for the application. The application identifier is allocated by the organization registered with the organization identifier who decides the policy for allocation within the organization.

The applicationIdentifier element may be defined by the application identifier type. the application identifier type includes an orgId element including the organization identifier and an appId element including the application identifier.

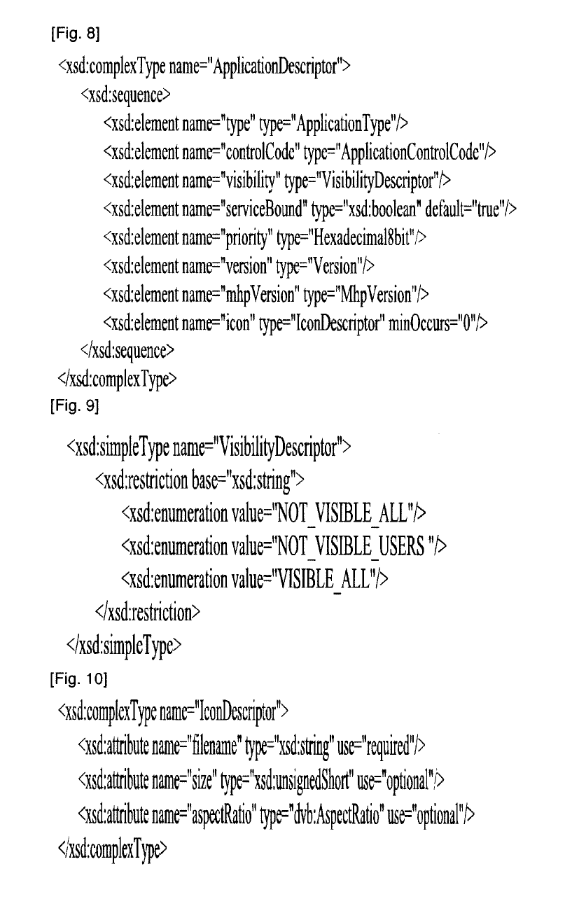

FIG. 8 is a view showing an XML schema of an exemplary embodiment of an application descriptor type.

Referring to FIG. 8, the applicationDescriptor element includes the application descriptor and may be defined by the application descriptor type. the application descriptor type includes type element, controlCode element, visibility element, serviceBound element, priority element, version element, mhpversion element and icon element.

The serviceBound element specifies whether the application is bound to a service or not as defined by the service_bound_flag.

The priority element identifies a relative priority between the applications signaled in this service. Where there is more than one application with the same Application identification this priority shall be used to determine which application is started. Where there are insufficient resources to continue running a set of applications, this priority shall be used to determine which applications to stop or pause. A larger integer value indicates higher priority. If two applications have the same application identification and the same priority, the present invention may make an implementation-dependent choice on which to start.

The version element includes information about Version of the application which starts at zero and increments by one each time any of the files listed in the “Application description file” change or the contents of the “Application description file” itself changes. Used values shall never be reused, in the event that the number range is exhausted a new application id shall be used.

FIG. 9 is a view showing an XML schema of an exemplary embodiment of a visibility descriptor type.

Referring to FIG. 9, the visibility element specifies whether the application is suitable to be offered to the end-user for them to decide if the application should be launched. Therefore “false” value means that application shall not be visible either to applications via an application listing API or to users via the navigator with the exception of any error reporting or logging facility, etc., whereas a “true” value means that application shall not be visible to users but shall be visible to applications via an application listing API.

The visibility element may be defined by the visibility descriptor type. the visibility descriptor type includes one of NOT_VISIBLE_ALWAYS, NOT_VISIBLE_USERS and VISIBLE_ALL as enumeration elements. Herein, the NOT_VISIBLE_ALWAYS indicates that this application shall not be visible either to applications via an application listing API or to users via the navigator with the exception of any error reporting or logging facility, etc. Also, the NOT_VISIBLE_USERS indicates that this application shall not be visible to users but shall be visible to applications via an application listing API. And the VISIBLE_ALL indicates that this application can be visible to users and shall be visible to applications via the application listing.

FIG. 10 is a view showing an XML schema of an exemplary embodiment of an icon descriptor type.

Referring to FIG. 10, the iconDescriptor element includes information for binding an icon to the application. Also, the iconDescriptor element serves to signal the presence of an icon representing the application.

The iconDescriptor element may be defined by the icon descriptor type. the icon descriptor type includes a filename attribute, a size attribute and a aspectRatio attribute. Herein, for example, the filename attribute includes “dvb.icon.1” and the size attribute includes 32*32 pixel square.

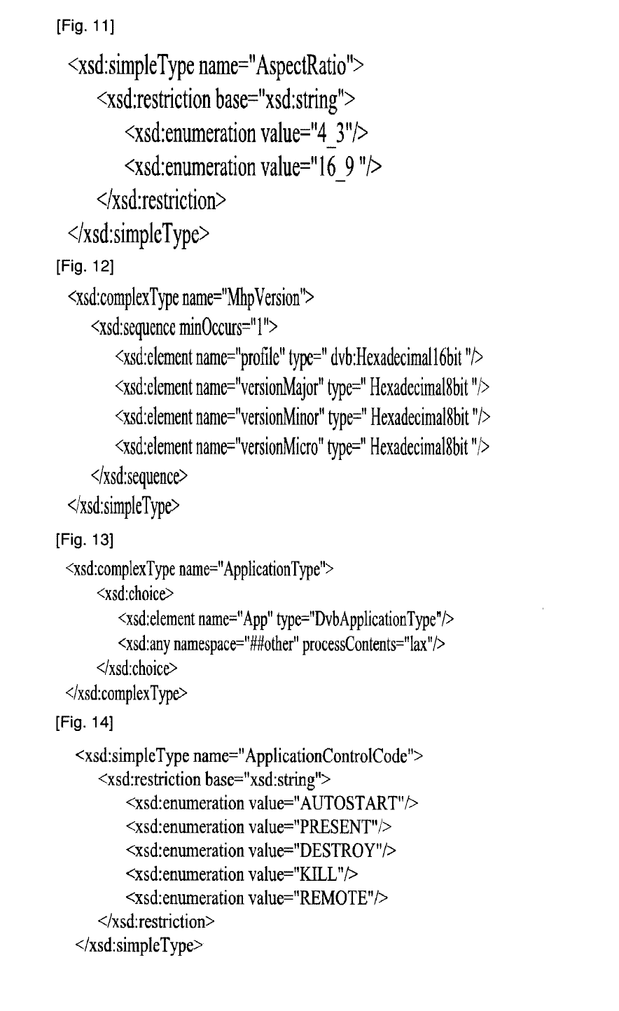

FIG. 11 is a view showing an XML schema of an exemplary embodiment of an aspect ratio type.

Referring to FIG. 11, the aspectRatio attributes may be defined by the aspect ratio type. the aspect ratio type includes one of 4_{—}3 and 16_{—}9 as enumeration elements.

FIG. 12 is a view showing an XML schema of an exemplary embodiment of a mhp version type.

Referring to FIG. 12, the mpVersion element includes information about version of the MHP and may be defined by the mhp version type. the mhp version type includes a profile element, a versionMajor element, a versionMinor element and a versionMicro element.

FIG. 13 is a view showing an XML schema of an exemplary embodiment of an application type.

Referring to FIG. 13, the application element includes information about the type of an application and may be defined by the application type. the application type includes one of App element and ##other any element. For example, when the ##other includes “application/ce-html+xml”, the application may be a CEHTML application.

FIG. 14 is a view showing an XML schema of an exemplary embodiment of an application control code type.

Referring to FIG. 14, the applicationControlCode element serves to dynamically control application life cycle and may be defined by the application control code type. the application control code includes AUTOSTART, PRESENT, DESTROY, KILL and REMOTE as enumeration elements. The meaning of each one of the enumeration elements indicates the expected behavior in the IPTV receiver.

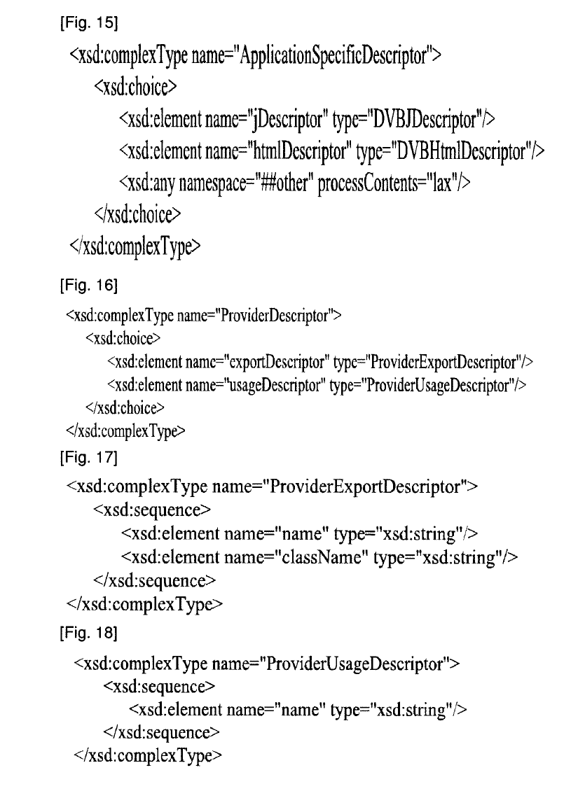

FIG. 15 is a view showing an XML schema of an exemplary embodiment of an application specific descriptor type.

Referring to FIG. 15, the applicationSpecificDescriptor element contains the application specific descriptor depending upon the type of application, e.g. J, HTML, CEHTML and may be defined by the application specific descriptor type. The application specific descriptor type may include one of jDescriptor element, htmlDescriptor element and ##other any element.

FIG. 16 is a view showing an XML schema of an exemplary embodiment of a provider descriptor type.

Referring to FIG. 16, the provider descriptor may be carried in the provider descriptor type. the provider descriptor type includes an exportDescriptor element and a usageDescriptor element.

FIG. 17 is a view showing an XML schema of an exemplary embodiment of a provider export descriptor type.

Referring to FIG. 17, the exportDescriptor element may be defined by the provider export descriptor type. The provider export descriptor type includes a name element containing a string specifying the name of the provider and a className element containing a string specifying the fully qualified name of the class in the application that implements the named provider.

FIG. 18 is a view showing an XML schema of an exemplary embodiment of a provider usage descriptor type.

Referring to FIG. 18, the usageDescriptor element may be defined by the provider usage descriptor type. The provider usage descriptor type includes a name element containing a string specifying the name of the provider.

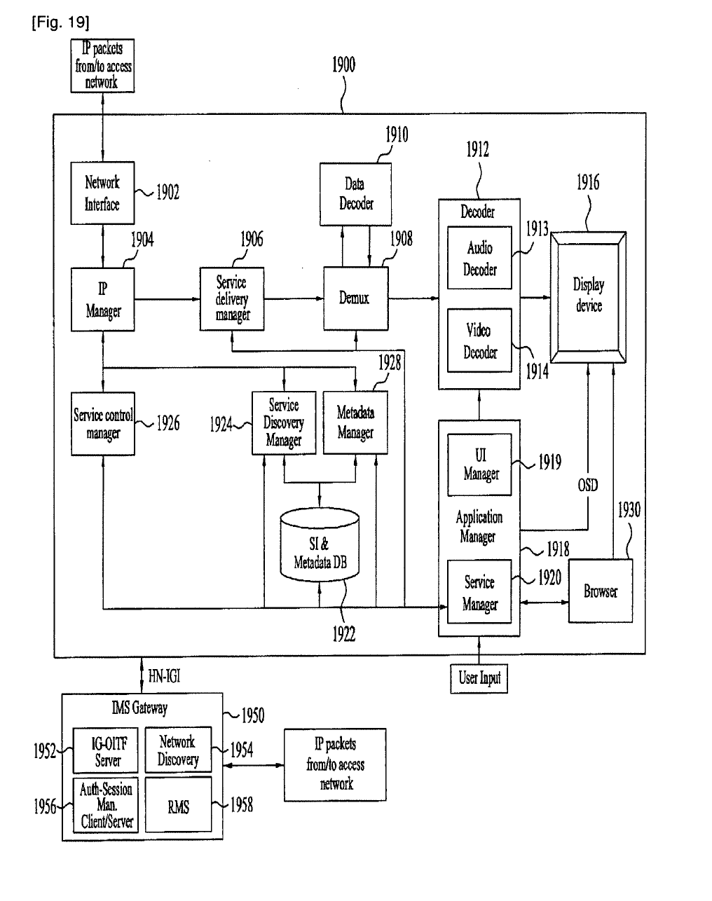

FIG. 19 is a block diagram of an IPTV receiver according to one preferred embodiment of the present invention.

Referring to FIG. 19, Referring to FIG. 19, an IPTV receiver 1900 may include a separate tuner for receiving terrestrial broadcast, cable broadcast, satellite broadcast and/or the like. For clarity and convenience of the description of the present invention, parts for processing a content transported via internet are mainly explained in the following description.

The IPTV receiver 1900 includes a network interface 1902, an IP manager 1904, a service delivery manager 1906, a demultiplexer 1908, a data decoder 1910, a decoder 1912, a display device 1916, an application manager 1918, a SI & Metadata database 1922, a service discovery manager 1924, a service control manager 1926, a metadata manager 1928 and a browser 1930.

The network interface 1902 receives packets received from a network and transmits packets to the network from the IPTV receiver 1900. Herein, the packets include IP packets. The IP packets may be IPTV packets including data related to an IPTV broadcast service. Also, the network interface 1902 performs functions of physical and data link layers. For instance, the network interface 1902 may receive IP packet delivering the content access descriptor shown in the FIG. 4.

The IP manager 1904 manages packet delivery to a destination from a source for the packets received or transmitted by the IPTV receiver 1900. And, the IP manager 1904 classifies the received packet into appropriate protocol manager.

The service delivery manager 1906 is responsible for a control of service data. For instance, in case of handling real-time streaming data, RTP/RTCP (real-time transport protocol/RTP control protocol) may be used with MPEG-2 TS. In case that the real-time streaming data is transported using RTP, MPEG-2 packets are encapsulated in RTP and the service delivery manager 1906 parses the received data packet according to the RTP and then transports the parsed packet to the demultiplexer 1908. The service delivery manager 1906 feeds back the network reception information to a server side that provides a service. For example, the service deliver manager 1906 may send feedback on the network reception quality using RTCP. In addition, MPEP-2 transport packets may be carried directly in UDP without RTP

The demultiplexer 1908 demultiplexes the received packet into audio, video, PSI (program specific information) data and the like. Herein, the received packet may be transport packets. Then, the demultiplexer 1908 makes the sections of PSI tables based on the demultiplexed PSI data and the like and sends them to data Decoder 1910. Also, the demultiplexer sends the demultiplexed audio and video data to the decoder 1912.

The decoder 1912 decodes the video and audio data received from the demultiplexer 1908. The decoder 1912 may include an audio decoder 1913 and a video decoder 1914. The video data decoded by the video decoder 1914 is provided to a user via the display device 1916. And, the decoded audio data decoded by the audio decoder 1913 is provided to the user via a speaker (not shown in the drawing).

The data decoder 1910 may include PSI (and PSIP/DVB-SI) Control Module. The date decoder 1910 sets PIDs for PSI tables and PSIP/DVB-SI (service information) tables to demultiplexer 1908 and decodes the private sections of PSI and (PSIP and/or DVB-SI) sent by demultiplexer 1908. The decoding result may be used to demultiplex input transport packet. (e.g set Audio and Video PID to the demultiplexer 1908).

Also, the data decoder 1910 establishes a database for service information by decoding the received sections. And, the database for the service information is stored in the SI & Metadata database 1922.

The display device 1916 receives the audio and video data from the decoder 1912 and then displays them on a Screen and a speaker. Also, the display device displays On Screen Display (OSD) Graphic data.

The application manager 1918 manages the states of the whole TV system, supports the Graphic User Interface on TV Screen and manages all the other managers related to the services like the service control manager 1926, the service delivery manager 1906, the service discovery manager 1924, the metadata manager 1928 and an IMS Gateway (IG)-OITF client.

Also, the application manager 1918 may receive a request for the COD content from a user and requests the content access descriptor shown in FIG. 4 to the service provider. Herein, the content access descriptor may include the relevant information related to fetch the request COD content and application information about an application related to the requested COD content. Then, the application manager 1918 controls to receive the application based on the application information. In this cast, the application manger may control the service control manager 1926 to request the content access descriptor to the service provider and receive the content access descriptor from service provider. The service control manager 1926 controls the IP manager 1904 to transmit a IP packet including the a request for the content access descriptor to the service provider and receives an IP packet delivering the content access descriptor.

Also, the application manager 1918 controls to receive the application based on the application information included in the received content access descriptor. In addition, the application manager 1918 may identify whether the application is provided based on the application information. Herein code data of the application may be transmitted with the COD content. For example, a stream including the code data of the application multiplexed with the COD content may be transmitted.

Also, the application manager 1918 controls to receive the COD content based on the relevant information included in the received content access descriptor.

The application manager 1918 includes an User Interface (UI) manager 1919 and a service manager 1920. The UI manager 1919 provides GUI (graphic user interface) for a user using OSD (on screen display) or the like. The UI manager 1919 receives a key input from a user and then performs a receiver operation according to the input. For instance, if a key input for a channel selection is received from a user, the UI manager 1919 sends the key input signal to the service manager 1920. If a key input for a request for a COD content is received from a user, the UI manager 1919 sends the key input signal to the service manager 1919.

The service manager 1920 controls all the other managers related to the services like the service control manager 1926, the service delivery manager 1906, the service discovery manager 1924, the metadata manager 1928 and an IMS Gateway (IG)-OITF client. Also, the service manager 1920 is responsible for serving IPTV services.

For example, the service manager 1920 prepares a channel map. The Service manager 1920 selects a channel according to the key input received from the UI manager 1919 using the channel map and controls the service delivery manager 1906 and the service control manager 1926. The service manager 1920 receives service information of a channel from the data decoder 1910 and then sets an audio/video PID (packet identifier) of the selected channel for the demultiplexer 1908.

The service manager 1920 requests the content access descriptor and controls to receive the requested COD content and the application related to the COD content using the content access descriptor.

The service discovery manager 1924 provides information required for selecting a service provider that provides a service. In case of receiving a signal for a channel selection from the application manager 1918, the service discovery manager 1924 discovers a service using the information.

In particular, the service discover manager 1924 receives a service discovery record, parses the received service discovery record, and then extracts information required for selecting a service provider and information required for receiving a service. In case of receiving a signal for a channel selection from the application manager 1918, the service discovery manager 1924 discovers a service provider using the information.

The service control manager 1926 is responsible for selecting and controlling service and managing sessions. For instance, if a user selects a live broadcasting service as good as a conventional broadcasting system, the service control manager 1926 performs the selection and control of service using IGMP, RTSP or the like. If a user selects such as service as VOD (video on demand), the service control manager 1926 performs the selection and control of service using RTSP. If the service control manager 1926 uses IMS for selecting and controlling services, SIP protocol is used for initiating and managing sessions through IMS Gateway.

The RTSP uses a persistent TCP connection and is able to provide a trick mode for real-time streaming. In addition, the RTSP can be used in controlling of the delivery of broadcast TV and audio as well as for on-demand delivery. The protocol is just exemplary and other protocols are available according to implementation examples.

The browser 1930 provides a Declarative Application Environment (DAE). The DAE may be a declarative language based environment based on CEA-2014 [CEA-2014, Web-based Protocol and Framework for Remote User Interface on UPnP™ Networks and the Internet (Web4CE)] for presentation of user interface and including scripting support for interaction with network server-side applications and access to the Application Protocol Interfaces (APIs) of the other OITF functions. Herein the APIs includes APIs available to the download applications. Also, the browser 1930 may query, internally to the service manager 1920 and the SI & Metadata database 1922 in order to extract any data it may contain.

The SI & Metadata database 1922 stores service discovery information and metadata related to the services. For instance, metadata may include the content access descriptor. The storage unit 1928 can be implemented by a non-volatile RAM (NVRAM), a flash memory and the like. And, the system manager 1930 controls overall operations of the IPTV receiver 1900 through power.

The IPTV receiver 1900 accesses an entry point of an IPTV portal and then receives a packet of a service provider discovery record. The network interface 1902 transports the received packet to the IP manager 1904. The IP manager 1904 checks whether a destination of the received packet is the receiver or not and then transports the packet to a suitable manager block according to a transmission/reception protocol.

Packet containing the service provider discovery information is transported using the protocol relevant to a service discovery and selection. For instance, in case of DVB-IP, the packet is transported according to SD&S (service discovery & selection) protocol (or, service discovery protocol: SDP). Therefore, the IP manager 1904 transports the packet containing the service provider discovery information to the service discovery manager 1924.

The service discovery manager 1924 parses the received packet and then obtains various kinds information of the service provider discovery record. The service discovery manager 1924 transports the information to the SI & Metadata database 1922. The information is then stored in the SI & Metadata database 1922.

The IPTV receiver 1900 is able to receive the packet containing service discovery information from a service provider using connection information of the service provider contained in the service provider discovery record. The packet containing the service discovery information is transported/received using SD&S protocol (or, SDP).

The service discovery record includes a broadcast discovery record, a COD (content on demand) discovery record, a package discovery record, a BCG discovery record and the like.

The packet containing the broadcast discovery information is transported to the IP manager 1904 via the network interface 1902. The IP manager 1904 checks whether the destination of the received packet is the IPTV receiver 1900 and then transports the packet to the service discovery manager 1924. The service discovery manager 1924 obtains broadcast discovery information from the received packet. The service discovery manager 1924 transports the information to the SI & Metadata database 1922. Hence, the information is stored in the SI & Metadata database 1922.

The SI & Metadata database 1922 stores and manages various kinds of the received information. The service manager 1920 makes and manages a channel map using various kinds of information stored in the SI & metadata database 1922.

The application manager 1918 receives channel information corresponding to a specific content from a user and then controls a channel to be switched according to the channel map. In particular, the application manager 1918 receives the channel information corresponding to the user-specific content and is then able to switch a channel.

The IPTV receiver 1900 accesses an address, at which a main service is stored, and an address, at which a COD content is stored, and is then able to be provided with the main service and the COD content.

The packet containing data of the selected main service and data of the selected COD content is sent to the IP manager 1904. The IP manager 1904 sends the main service to the service delivery manager 1906. And the IP manager 1904 sends the COD content to service control manager 1926 or service delivery manager 1906.

The service manager 1920 displays the COD content by controlling the browser 1930. The service manager 1920 may control the browser to display the COD content with an application related to the COD content. The browser 1930 displays the COD content on the display device. If there is the application related to the COD content, the browser 1930 executes the application related to the COD content. Herein, a graphic which is generated by the application may be displayed on the Screen together with the COD content.

The service manager 1920 demultiplexes the packet containing the main service data by controlling the demultiplexer 1908. The service manager 1920 controls the demultiplexing using PID (packet ID), an access address or the like.

The demultiplexed service data is decoded by the decoder 1912 and is then displayed on the display device 1916.

An IP Multimedia Subsystem (IMS) gateway 1950 provides functions for accessing an IPTV services over an IP Multimedia Subsystem (IMS). The IMS provides a common core network having access-agnostic network architecture for converged networks. Service providers are accepting this architecture in next generation network evolution. The IMS architecture is initially defined by the 3GPP to provide multimedia services to mobile subscribers over an IP network. IP networks have become the most cost savings bearer network to transmit video, voice, and data. IMS uses the advantage of IP networks to provide multimedia services for IMS subscribers on an IMS platform.

The IMS gateway 1950 includes an IG-OITV server 1952, a Network Discovery 1954, an authentication/session management client/Server 1956 and RMS 1958. The IPTV receiver 1900 may use the IPTV services over the IMS by interfacing with the IMS gateway 1950. Herein, the IPTV receiver 1900 may interface with the IMS gateway 1950 using a HNI_IGI interface. The HNI_IGI interface enables the IPTV receiver 1900 to use functions of the IMS gateway 1950 such that the IPTV receiver uses the IPTV services over the INS.

The IG-OITV server 1952 exposes functionalities of authentication/session management client/Server 1956 to the IPTV receiver 1900 for managed IPTV services via HTTP and/or other protocols as required.

The Network Discovery 1954 is responsible for the discovery of and attachment to an IMS service.

The authentication/session management client/server 1956 is responsible for subscriber authentication and any session management required of managed networks.

The RMS 1958 is responsible for remote management functions in a managed environment.

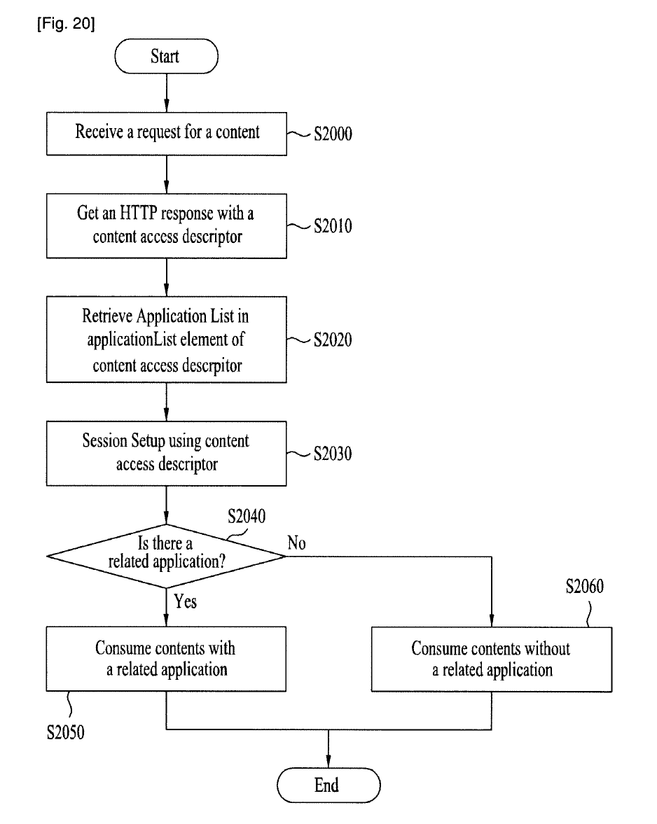

FIG. 20 is a flowchart of a method for receiving application in an IPTV receiver to one preferred embodiment of the present invention.

Referring to FIG. 20, a controller receives a request for a COD content from a user [S200]. Herein, the controller may include at least one of the application manager 1918 and the browser 1930.

Then, the controller requests a content access descriptor to the service provider and gets an HTTP response with the content access descriptor [S2010]. In this case, the Network Interface 1902 may receive an Internet Protocol (IP) packet delivering the content access descriptor shown in the FIG. 4.

Herein, the content access descriptor includes application information about an application related to the requested COD content. The application information includes application name information, application identification information, an application descriptor, an application specific descriptor and a provider descriptor.

Moreover, the content access descriptor includes relevant information related to fetch the COD content. The relevant information includes a content identifier, name information, description information, content type information, content size information and a content Uniform Resource Locator (URL).

The controller retrieves application list in applicationList element of the content access descriptor [S2020]. The controller controls session setup using the content access descriptor. In this case, the application manager 1918 may control to receive the COD content based on the relevant information [S2030].

The controller identifies whether there is the application [S2040]. In this case, the controller may identify whether the application is provided based on the application information. If the application exists, the controller consumes the COD content with the application. [S2050]. For instance, the controller displays the COD content on a Screen together with graphics generated by the application.

If the application does not exist, the controller consumes the COD content without the application [s2060].

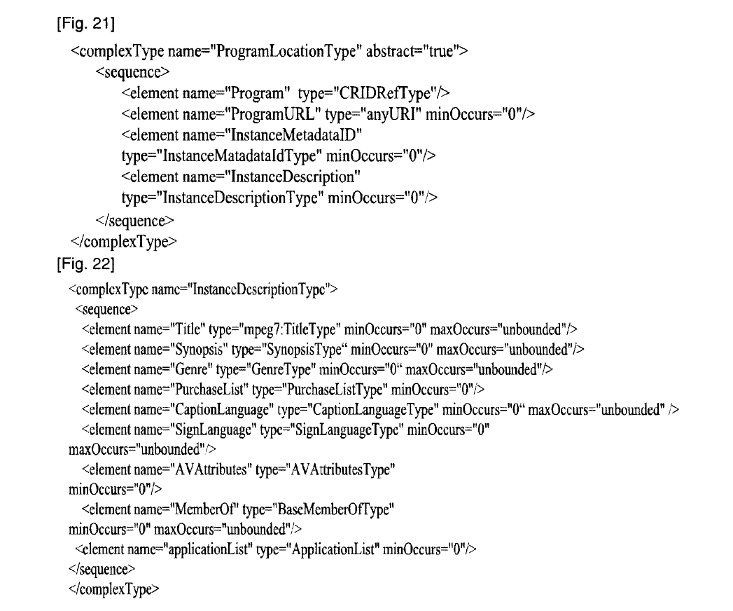

FIG. 21 is a view showing an XML schema of an exemplary embodiment of a program location type.

Referring to FIG. 21, an Instance description metadata includes a programLocation element and associates metadata with a piece of content. The key for linking content metadata to content is a Content Reference Identifier (CRID) being identifier for content that is independent of its location. The instance description metadata is useful in cases where there are meaningful differences between instances of the same content (that is, instances of content that share the same CRID). The instance description metadata is linked to a particular event-related instance of content.

The programLocation element may include a program location. The program location represents a generic program location, regardless of the nature of the medium it addresses—two obvious examples being broadcast services and the Web. The principle feature of a program location is that it may “contain” at most one program.

For instance, the programLocation element may be defined by the program location type. The program location type includes a Program element, a ProgramURL element, an instanceMetadataID element and an instanceDescription element. The program element includes a reference to the CRID that this description describes. The ProgramURL element includes a URL for specifying a program location. And the instanceMetadataID element includes an Instance metadata ID being an optional identifier that shall identify a particular location related to a CRID (i.e. a program). This identifier may be unique within the CRID domain and have the same life cycle as the CRID.

FIG. 22 is a view showing an XML schema of an exemplary embodiment of an instance description type.

Referring to FIG. 22, the instanceDescription element includes descriptive information and application information and may be defined by the instance description type. The instance description type includes a Title element, a synopsis element, a genre element, a purchaseList element, a captionLanguage element, a signLanguage element, a AVAttributes element, a memberOf element and an applicationList element.

The title element includes a title of the program. An instance of a program can have a different title. When this element exists, it completely overrides any Title with corresponding attributes that might exist for the corresponding program information object.

The synopsis element includes a textual description of this instance. Typically, the synopsis for a program will be described in the programInformation type and the instance description will not contain a synopsis. However, in some cases a service provider may wish to supply a synopsis for a particular instance of content that includes event-specific information. For example, a showing of a film that is a tribute to a recently deceased director. When this element exists, it completely overrides any Synopsis with corresponding attributes that might exist for the corresponding program information object.

The genre element includes a genre for the program. The genre attributes specified in the instance description update their counterparts that may have been acquired from preliminary program information tables.

The purchaseList element includes a list of purchase items.

The captionLanguage element includes information describing one language of the caption information included with the program. The type of the caption information associated with the program is denoted by the closed attribute. Closed captions can be turned on or off by the user, while open captions (or subtitles) are part of the picture itself and remain visible.

The signLanguage element includes information specifying the sign language provided for the multimedia content and, optionally, qualifying the use of signing as a primary language and/or as a translation of the spoken dialogue.

The AVAttributes element includes Technical (audio-visual) attributes about this particular instance. The audio-visual attributes specified in the instance description completely override their counterparts in the program information.

The memberOf element includes a list of groups of which the program is a member. This list updates a list that may have been acquired from preliminary program information tables.

The applicationList element includes the application information. The application information includes application name information, application identification information, an application descriptor, an application specific descriptor and a provider descriptor.

And the application information may be included in a applicationList element. The applicationList element may be defined by the application list type shown in the FIG. 5.

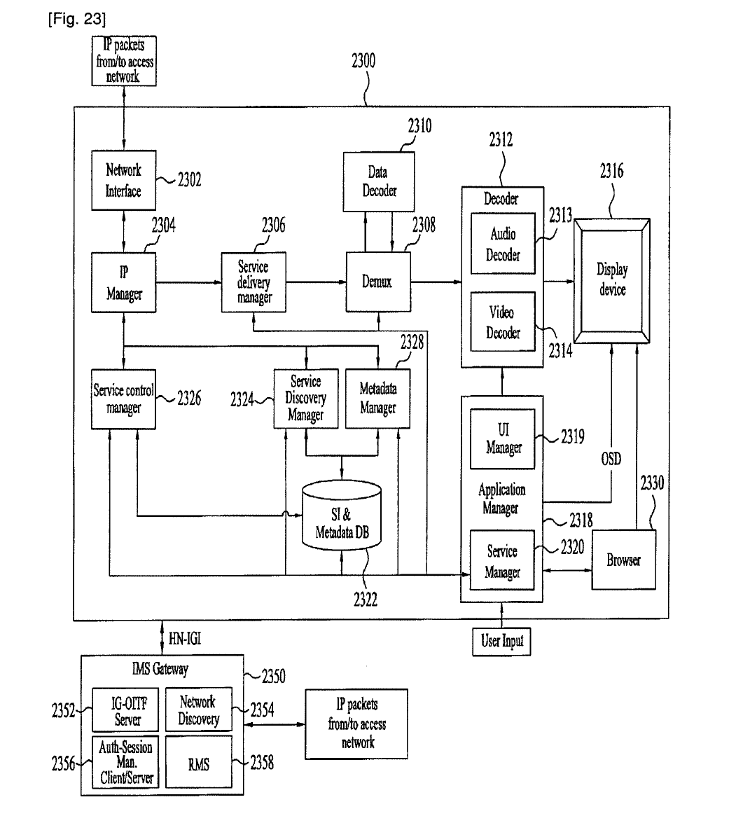

FIG. 23 is a block diagram of an IPTV receiver according to another preferred embodiment of the present invention.

Referring to FIG. 23, an IPTV receiver 2300 may include a separate tuner for receiving terrestrial broadcast, cable broadcast, satellite broadcast and/or the like. For clarity and convenience of the description of the present invention, parts for processing a content transported via internet are mainly explained in the following description.

The IPTV receiver 2300 includes a network interface 2302, an IP manager 2304, a service delivery manager 2306, a demultiplexer 2308, a data decoder 2310, a decoder 2312, a display device 2316, an application manager 2318, a SI & Metadata database 2322, a service discovery manager 2324, a service control manager 2326, a metadata manager 2328 and a browser 2330.

The network interface 2302 receives packets received from a network and transmits packets to the network from the IPTV receiver 2300. Herein, the packets include IP packets. The IP packets may be IPTV packets including data related to an IPTV broadcast service. Also, the network interface 2302 performs functions of physical and data link layers. For instance, the network interface 2302 may receive IP packet delivering instance description metadata including a programLocation element shown in the FIG. 21.

The IP manager 2304 manages packet delivery to a destination from a source for the packets received or transmitted by the IPTV receiver 2300. And, the IP manager 2304 classifies the received packet into appropriate protocol manager.

The service delivery manager 2306 is responsible for a control of service data. For instance, in case of handling real-time streaming data, RTP/RTCP (real-time transport protocol/RTP control protocol) may be used with MPEG-2 TS. In case that the real-time streaming data is transported using RTP, MPEG-2 packets are encapsulated in RTP and the service delivery manager 2306 parses the received data packet according to the RTP and then transports the parsed packet to the demultiplexer 2308. The service delivery manager 2306 feeds back the network reception information to a server side that provides a service. For example, the service deliver manager 2306 may send feedback on the network reception quality using RTCP. In addition, MPEP-2 transport packets may be carried directly in UDP without RTP

The demultiplexer 2308 demultiplexes the received packet into audio, video, PSI (program specific information) data and the like. Then, the demultiplexer 2308 makes the sections of PSI tables based on the demultiplexed PSI data and the like and sends them to data Decoder 2310. Also, the demultiplexer sends the demultiplexed audio and video data to the decoder 2312.

The decoder 2312 decodes the video and audio data received from the demultiplexer 2308. The decoder 2312 may include an audio decoder 2313 and a video decoder 2314. The video data decoded by the video decoder 2314 is provided to a user via the display device 2316. And, the decoded audio data decoded by the audio decoder 2313 is provided to the user via a speaker (not shown in the drawing).

The data decoder 2310 may include PSI (and PSIP/DVB-SI) Control Module. The date decoder 2310 sets PIDs for PSI tables and PSIP/DVB-SI (service information) tables to demultiplexer 2308 and decodes the private sections of PSI and (PSIP and/or DVB-SI) sent by demultiplexer 2308. The decoding result may be used to demultiplex input transport packet (e.g set Audio and Video PID to the demultiplexer 2308).

Also, the data decoder 2310 establishes a database for service information by decoding the received sections. And, the database for the service information is stored in the SI & Metadata database 2322.

The display device 2316 receives the audio and video data from the decoder 2312 and then displays them on a Screen and a speaker. Also, the display device displays On Screen Display (OSD) Graphic data.

The application manager 2318 manages the states of the whole TV system, supports the Graphic User Interface on TV Screen and manages all the other managers related to the services like the service control manager 2326, the service delivery manager 2306, the service discovery manager 2324, the metadata manager 2328 and an IMS Gateway (IG)-OITF client.

Also, the application manager 2318 may receive a request for the COD content from a user and identifies whether Authority is known. If the Authority is not known, the application manager 2318 requests CRID resolution to a remote Location Resolution Server. And the application manager 2318 identifies whether the CRID resolution is success. If the CRID resolution is success, the application manager 2318 gets an instance metadata ID of a Locator corresponding to the requested COD content. Herein, the instance metadata ID is an optional identifier that shall identify a particular location related to a CRID (i.e. a program). This identifier may be unique within the CRID domain and have the same life cycle as the CRID.

If the Authority is known, the application manager 2318 performs local CRID resolution. And the application manager 2318 identifies whether the local CRID resolution is success. If the local CRID resolution is success, the application manager 2318 gets the instance metadata ID of a Locator corresponding to the requested COD content.

The application manager 2318 retrieves an instance description metadata which has same with the got instance metadata ID. Herein, the instance description metadata includes a programLocation element and associates metadata with a piece of content. The programLocation element may include a program location representing a generic program location, regardless of the nature of the medium it addresses. For instance, the programLocation element may be defined by the program location type shown in the FIG. 21.

The application manager 2318 retrieves application List in applicationList element of instanceDescription element included in the programLocation element. The application manager 2318 controls session setup. For instance, the instanceDescription element may be defined by the instance description type shown in the FIG. 22.

The application manager 2318 identifies whether there is the application. In this case, the application manager 2318 may identify whether the application is provided based on the application information.

The application manager 2318 includes an User Interface (UI) manager 2319 and a service manager 2320. The UI manager 2319 provides GUI (graphic user interface) for a user using OSD (on screen display) or the like. The UI manager 2319 receives a key input from a user and then performs a receiver operation according to the input. For instance, if a key input for a channel selection is received from a user, the UI manager 2319 sends the key input signal to the service manager 2320. If a key input for a request for a COD content is received from a user, the UI manager 2319 sends the key input signal to the service manager 2319.

The service manager 2320 controls all the other managers related to the services like the service control manager 2326, the service delivery manager 2306, the service discovery manager 2324, the metadata manager 2328 and an IMS Gateway (IG)-OITF client. Also, the service manager 2320 is responsible for serving IPTV services.

For example, the service manager 2320 prepares a channel map. The Service manager 2320 selects a channel according to the key input received from the UI manager 2319 using the channel map and controls the service delivery manager 2306 and the service control manager 2326. The service manager 2320 receives service information of a channel from the data decoder 2310 and then sets an audio/video PID (packet identifier) of the selected channel for the demultiplexer 2308.

The service manager 2320 requests the CRID resolution to a remote Location Resolution Server and controls to receive the requested COD content and the application related to the COD content using the descriptive information and the application information.

The service discovery manager 2324 provides information required for selecting a service provider that provides a service. In case of receiving a signal for a channel selection from the application manager 2318, the service discovery manager 2324 discovers a service using the information.

In particular, the service discover manager 2324 receives a service discovery record, parses the received service discovery record, and then extracts information required for selecting a service provider and information required for receiving a service. In case of receiving a signal for a channel selection from the application manager 2318, the service discovery manager 2324 discovers a service provider using the information.

The service control manager 2326 is responsible for selecting and controlling service and managing sessions. For instance, if a user selects a live broadcasting service as good as a conventional broadcasting system, the service control manager 2326 performs the selection and control of service using IGMP, RTSP or the like. If a user selects such as service as VOD (video on demand), the service control manager 2326 performs the selection and control of service using RTSP. If the service control manager 2326 uses IMS for selecting and controlling services, SIP protocol is used for initiating and managing sessions through IMS Gateway.

The RTSP uses a persistent TCP connection and is able to provide a trick mode for real-time streaming. In addition, the RTSP can be used in controlling of the delivery of broadcast TV and audio as well as for on-demand delivery. The protocol is just exemplary and other protocols are available according to implementation examples.

The browser 2330 provides a Declarative Application Environment (DAE). The DAE may be a declarative language based environment based on CEA-2014 [CEA-2014, Web-based Protocol and Framework for Remote User Interface on UPnP™ Networks and the Internet (Web4CE)] for presentation of user interface and including scripting support for interaction with network server-side applications and access to the Application Protocol Interfaces (APIs) of the other OITF functions. Herein the APIs includes APIs available to the download applications. Also, the browser 2330 may query, internally to the service manager 2320 and the SI & metadata database 2322 in order to extract any data it may contain.

The SI & metadata database 2322 stores service discovery information and metadata related to the services. For instance, metadata may include the instance description metadata. The storage unit 2328 can be implemented by a non-volatile RAM (NVRAM), a flash memory and the like. And, the system manager 2330 controls overall operations of the IPTV receiver 2300 through power.

The IPTV receiver 2300 accesses an entry point of an IPTV portal and then receives a packet of a service provider discovery record. The network interface 2302 transports the received packet to the IP manager 2304. The IP manager 2304 checks whether a destination of the received packet is the IPTV receiver or not and then transports the packet to a suitable manager block according to a transmission/reception protocol.

Packet containing the service provider discovery information is transported using the protocol relevant to a service discovery and selection. For instance, in case of DVB-IP, the packet is transported according to SD&S (service discovery & selection) protocol (or, service discovery protocol: SDP). Therefore, the IP manager 2304 transports the packet containing the service provider discovery information to the service discovery manager 2324.

The service discovery manager 2324 parses the received packet and then obtains various kinds information of the service provider discovery record. The service discovery manager 2324 transports the information to the SI & metadata database 2322. The information is then stored in the SI & metadata database 2322.

The IPTV receiver 2300 is able to receive the packet containing service discovery information from a service provider using connection information of the service provider contained in the service provider discovery record. The packet containing the service discovery information is transported/received using SD&S protocol (or, SDP).

The service discovery record includes a broadcast discovery record, a COD (content on demand) discovery record, a package discovery record, a BCG discovery record and the like.

The packet containing the broadcast discovery information is transported to the IP manager 2304 via the network interface 2302. The IP manager 2304 checks whether the destination of the received packet is the IPTV receiver 2300 and then transports the packet to the service discovery manager 2324. The service discovery manager 2324 obtains broadcast discovery information from the received packet. The service discovery manager 2324 transports the information to the SI & metadata database 2322. Hence, the information is stored in the SI & metadata database 2322.

The SI & metadata database 2322 stores and manages various kinds of the received information. The Service manager 2320 makes and manages a channel map using various kinds of information stored in the SI & metadata database 2322.

The application manager 2318 receives channel information corresponding to a specific content from a user and then controls a channel to be switched according to the channel map. In particular, the application manager 2318 receives the channel information corresponding to the user-specific content and is then able to switch a channel.

The IPTV receiver 2300 accesses an address, at which a main service is stored, and an address, at which a COD content is stored, and is then able to be provided with the main service and the COD content.

The packet containing data of the selected main service and data of the selected COD content is sent to the IP manager 2304. The IP manager 2304 sends the main service to the service delivery manager 2306. And the IP manager 2304 sends the COD content to service control manager 2326 or service delivery manager 2306.

The service manager 2320 displays the COD content by controlling the browser 2330. The service manager 2320 may control the browser to display the COD content with an application related to the COD content. The browser 2330 displays the COD content on the display device. If there is the application related to the COD content, the browser 2330 executes the application related to the COD content. Herein, a graphic which is generated by the application may be displayed on the Screen together with the COD content.

The service manager 2320 demultiplexes the packet containing the main service data by controlling the demultiplexer 2308. The service manager 2320 controls the demultiplexing using PID (packet ID), an access address or the like.

The demultiplexed service data is decoded by the decoder 2312 and is then displayed on the display device 2316.

An IP Multimedia Subsystem (IMS) gateway 2350 provides functions for accessing an IPTV services over an IP Multimedia Subsystem (IMS). The IMS provides a common core network having access-agnostic network architecture for converged networks. Service providers are accepting this architecture in next generation network evolution. The IMS architecture is initially defined by the 3GPP to provide multimedia services to mobile subscribers over an IP network. IP networks have become the most cost savings bearer network to transmit video, voice, and data. IMS uses the advantage of IP networks to provide multimedia services for IMS subscribers on an IMS platform.

The IMS gateway 2350 includes an IG-OITV server 2352, a Network Discovery 2354, an authentication/session management client/Server 2356 and RMS 2358. The IPTV receiver 2300 may use the IPTV services over the IMS by interfacing with the IMS gateway 2350. Herein, the IPTV receiver 2300 may interface with the IMS gateway 2350 using a HNI_IGI interface. The HNI_IGI interface enables the IPTV receiver 2300 to use functions of the IMS gateway 2350 such that the IPTV receiver uses the IPTV services over the INS.

The IG-OITV server 2352 exposes authentication/session management client/Server 2356 functionalities to the IPTV receiver 2300 for managed IPTV services via HTTP and/or other protocols as required.

The Network Discovery 2354 is responsible for the discovery of and attachment to an IMS service.

The authentication/session management client/server 2356 is responsible for subscriber authentication and any session management required of managed networks.

The RMS 2358 is responsible for remote management functions in a managed environment.

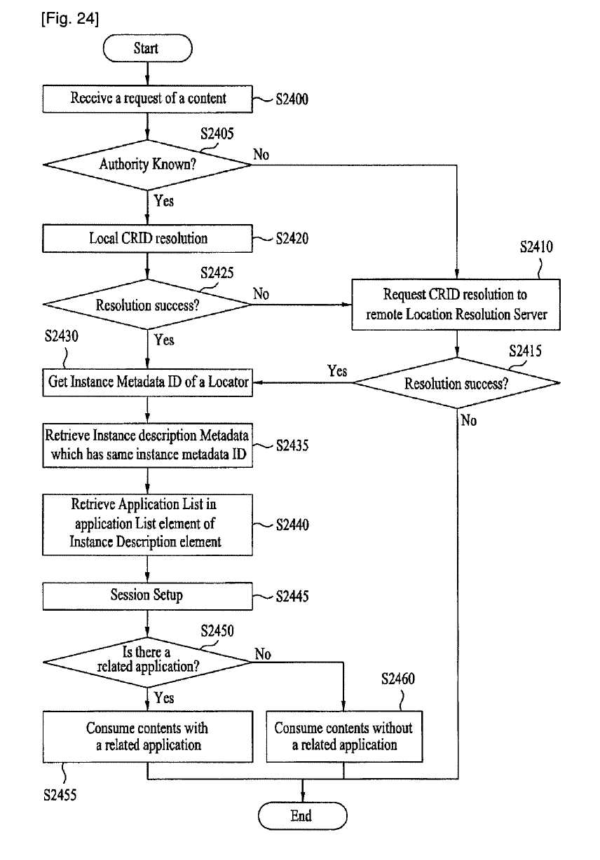

FIG. 24 is a flowchart of a method for receiving application in an IPTV receiver to one preferred embodiment of the present invention.

Referring to FIG. 24, a controller receives a request for a COD content from a user [S2400]. Herein, the controller may include at least one of the application manager 2318 and the browser 2330.

Then, the controller identifies whether Authority is known [S2405]. If the Authority is not known, the controller requests CRID resolution to a remote Location Resolution Server [s2410]. And the controller identifies whether the CRID resolution is success [s2415]. If the CRID resolution is success, the controller gets an instance metadata ID of a Locator corresponding to the requested COD content [s2430]. Herein, the instance metadata ID is an optional identifier that shall identify a particular location related to a CRID (i.e. a program). This identifier may be unique within the CRID domain and have the same life cycle as the CRID.

If the Authority is known, the controller performs local CRID resolution [s2420]. And the controller identifies whether the local CRID resolution is success [s2435]. If the local CRID resolution is not success, the controller performs the step s2410.

If the local CRID resolution is success, the controller performs the step s2430.

The controller retrieves an instance description metadata which has same with the got instance metadata ID [S2435]. Herein, the instance description metadata includes a programLocation element and associates metadata with a piece of content. The programLocation element may include a program location representing a generic program location, regardless of the nature of the medium it addresses. For instance, the programLocation element may be defined by the program location type shown in the FIG. 21.

The controller retrieves application List in applicationList element of instanceDescription element included in the programLocation element [S2440]. The controller controls session setup [s2445]. For instance, the instanceDescription element may be defined by the instance description type shown in the FIG. 22. And the applicationList element may be defined by the application list type shown in the FIG. 5.

The controller identifies whether there is the application [S2450]. In this case, the controller may identify whether the application is provided based on the application information. If the application exists, the controller consumes the COD content with the application. [S2455]. For instance, the controller displays the COD content on a Screen together with graphics generated by the application.

If the application does not exist, the controller consumes the COD content without the application [s2460].

As is apparent from the above description, the present invention provides an IPTV receiver and a method of receiving application information an IPTV receiver, which have advantages in that it is possible for a service provider to announce application list related to a COD content and to signal information about each application. Also, it is possible for an IPTV receiver to consume a COD content with the application and provide an opportunity to select an execution of the application to the user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. An Internet Protocol TV (IPTV) receiver comprising:
a network interface configured to receive an Internet Protocol (IP) packet delivering a content access descriptor including application information about an application related to a Content On Demand (COD) content; and
a controller configured to receive a request for the COD content, request the content access descriptor and control to receive the application based on the application information.

2. The IPTV receiver according to claim 1, wherein the content access descriptor further includes relevant information related to fetch the COD content.

3. The IPTV receiver according to claim 2, wherein the relevant information includes at least one of a content identifier, name information, description information, content type information, content size information and a content Uniform Resource Locator (URL).

4. The IPTV receiver according to claims 2, the controller controls to receive the COD content based on the relevant information.

5. An Internet Protocol TV (IPTV) receiver comprising:
a network interface configured to receive an Internet Protocol (IP) packet delivering instance description metadata including application information about an application related to a Content On Demand (COD) content; and
a controller configured to receive a request of the COD content, get instance metadata ID of a program location corresponding to the COD content, retrieve instance description metadata having the instance metadata ID and control to receive the application based on the application information included in the retrieved instance description metadata.

6. The IPTV receiver according to the claim 5, wherein the instance description metadata includes a program location element, the program location element including at least one of a program element including a reference to a Content Reference Identifier (CRID), program Uniform Resource Locator (URL) element including a URL for specifying a program location, instance metadata ID element including the instance metadata ID and instance description element including descriptive information and the application information.

7. The IPTV receiver according to claim 1, wherein the controller identifies whether the application is provided based on the application information.

8. The IPTV receiver according to claim 1, wherein the application information includes at least one of application name information, application identification information, an application descriptor, an application specific descriptor and a provider descriptor.

9. A method for receiving application information in an Internet Protocol TV (IPTV) receiver, the method comprising:
receiving a request for a Content On Demand (COD) content and requesting a content access descriptor including application information about an application related to the requested Content On Demand (COD) content; and
receiving an Internet Protocol (IP) packet delivering the content access descriptor and receiving the application based on the application information.

10. The method according to claim 9, wherein the content access descriptor further includes relevant information related to fetch the COD content, the relevant information including at least one of a content identifier, name information, description information, content type information, content size information and a content Uniform Resource Locator (URL).

11. The method according to claim 10, wherein receiving the application includes receiving the COD content based on the relevant information.

12. A method for receiving application information in an Internet Protocol TV (IPTV) receiver, the method comprising:
receiving a request of a Content On Demand (COD) content and getting instance metadata ID of a program location corresponding to the COD content;
retrieving instance description metadata having the instance metadata ID, the instance description metadata including application information about an application related to a COD content; and
receiving the application based on the application information included in the retrieved instance description metadata.

13. The method according to the claim 12, wherein the instance description metadata includes a program location element, the program location element including at least one of a program element including a reference to a Content Reference Identifier (CRID), program Uniform Resource Locator (URL) element including a URL for specifying a program location, instance metadata ID element including the instance metadata ID and instance description element including descriptive information and the application information.

14. The method according to claim 9, further comprising:
identifying whether the application is provided based on the application information.

15. The method according to claim 9, the application information includes at least one of application name information, application identification information, an application descriptor, an application specific descriptor and a provider descriptor.

16. The IPTV receiver according to claim 5, wherein the controller identifies whether the application is provided based on the application information.

17. The IPTV receiver according to claim 5, wherein the application information includes at least one of application name information, application identification information, an application descriptor, an application specific descriptor and a provider descriptor.

18. The method according to claim 12, further comprising:
identifying whether the application is provided based on the application information.

19. The method according to claim 12, the application information includes at least one of application name information, application identification information, an application descriptor, an application specific descriptor and a provider descriptor.
